(19) United States
(12) Patent Application Publication
(10) Pub. No.: US 2004/0071123 A1
(43) Pub. Date: Apr. 15, 2004

(54) Apparatus and method for linking bluetooth to wireless LAN

(75) Inventor: Sang-hyun Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/457,382

(22) Filed: Jun. 10, 2003

(30) Foreign Application Priority Data
Jul. 2, 2002 (JP) 2002-37865

(51) Int. Cl. H04Q 7/24

(52) U.S. Cl. 370/338; 370/466

(57) ABSTRACT

Apparatuses and methods for linking a wireless LAN terminal and a Bluetooth terminal, for enabling communications between the terminals, and for enabling establishment of an ad-hoc network between the terminals are provided. A first linking apparatus includes a first data conversion unit which receives a Bluetooth signal and converts it to common layer data; and a first signal conversion unit which converts the common layer data into a wireless LAN signal and transmits it. A second linking apparatus includes a second data conversion unit which receives a wireless LAN signal and converts it into common layer data; and a second signal conversion unit which converts the common layer data into a Bluetooth signal and transmits it. Thus, by linking Bluetooth terminals and wireless LAN terminals, communications between the terminals, which use different technologies, are enabled, and an ad-hoc network can be established between the terminals.

### BACKGROUND OF THE INVENTION

1. Field of the Invention

The present invention relates to an apparatus and method for linking a wireless LAN terminal and a Bluetooth (a trademark of Bluetooth SIG, Inc.) terminal and enabling communications between the terminals, and more particularly, to an apparatus and method for enabling establishment of an ad-hoc network between a wireless LAN terminal and a Bluetooth terminal. The present application is based on Korean Application No. 2002-37865, filed on Jul. 2, 2002, which is incorporated herein by reference.

2. Description of the Related Art

Since the introduction of the Internet, the world has become increasingly networked. With recent development of wireless technologies, the wireless Internet using a variety of technologies, such as a code division multiple access (CDMA), a wireless LAN, an infrared data association (IrDA) technology, and a Bluetooth technology, has also been highlighted and widely used by ordinary users. In addition, with the wireless LAN or Bluetooth technology, an ad-hoc network between terminals that use the same technology and are not connected to the Internet can be established.

The prior art wireless LAN terminal has hardware and software for wireless LAN communications, and the prior art Bluetooth terminal has hardware and software for Bluetooth communications. Based on a wireless LAN protocol, wireless LAN terminals can establish an ad-hoc network among the terminals. Similarly, among Bluetooth terminals, first, it is determined whether or not there is a service profile that wants communications between terminals through a service discovery protocol (SDP) of Bluetooth, and if there is a common profile, communications are performed through a procedure described in the profile.

Accordingly, if a terminal has a Bluetooth module, the terminal can communicate only with a terminal that has a Bluetooth module, and if a terminal has a wireless LAN module, the terminal can communicate only with a terminal that has a wireless LAN module. Also, since communications between the Bluetooth terminal and the wireless LAN terminal are impossible, an ad-hoc network cannot be established between the Bluetooth terminals and the wireless LAN terminals that use different technologies.

### SUMMARY OF THE INVENTION

The present invention provides an apparatus and method for linking a Bluetooth terminal and a wireless LAN terminal that use different technologies, and enabling communications between the terminals.

The present invention also provides an apparatus and method for establishing an ad-hoc network between Bluetooth terminals and wireless LAN terminals using the apparatus for linking a Bluetooth terminal and a wireless LAN terminal.

According to an exemplary aspect of the present invention, there is provided a Bluetooth-to-wireless local area network (LAN) linking apparatus comprising a Bluetooth signal-to-common layer data conversion unit which receives a Bluetooth signal and converts the Bluetooth signal to common layer data; and a common layer data-to-wireless LAN signal conversion unit which converts the common layer data into a wireless LAN signal and transmits the wireless LAN signal.

According to another exemplary aspect of the present invention, there is provided a wireless LAN-to-Bluetooth linking apparatus comprising a wireless LAN-to-common layer data conversion unit which receives a wireless LAN signal and converts the received wireless LAN signal to common layer data; and a common layer data-to-Bluetooth signal conversion unit which converts the common layer data into a Bluetooth signal and transmits the Bluetooth signal.

According to still another exemplary aspect of the present invention, there is provided an apparatus for establishing an ad-hoc network of Bluetooth and wireless LAN comprising a Bluetooth search IP address allocation unit which receives a search signal from an arbitrary Bluetooth terminal, accesses the Bluetooth terminal, and allocates an IP address to the accessed Bluetooth terminal; a wireless LAN search IP address allocation unit which receives a search signal from an arbitrary wireless LAN terminal, accesses the wireless LAN terminal, and allocates an IP address to the accessed wireless LAN terminal; a Bluetooth-to-wireless LAN linking unit which receives a Bluetooth signal from an arbitrary Bluetooth terminal, converts the received Bluetooth signal into common layer data, converts the common layer data into a wireless LAN signal, and transmits the wireless LAN signal to a wireless LAN terminal to which an IP address included in the wireless LAN signal is allocated; and a wireless LAN-to-Bluetooth linking unit which receives a wireless LAN signal from an arbitrary wireless LAN terminal, converts the received wireless LAN signal into common layer data, converts the common layer data into a Bluetooth signal, and transmits the Bluetooth signal to a Bluetooth terminal to which an IP address included in the Bluetooth signal is allocated.

### BRIEF DESCRIPTION OF THE DRAWINGS

The above exemplary objects and advantages of the present invention will become more apparent by describing in detail various illustrative, non-limiting embodiments thereof with reference to the attached drawings in which:

FIG. 1 is a diagram of the structure of a prior art Bluetooth protocol stack;

FIG. 2 is a diagram of the structure of a prior art wireless LAN protocol stack;

FIG. 3 is a diagram of the structure of a mixed protocol stack of Bluetooth and wireless LAN of the present invention;

FIG. 4 is a diagram of the structure of a Bluetooth-to-wireless LAN linking apparatus of the present invention;

FIG. 5 is a diagram of the structure of a wireless LAN-to-Bluetooth linking apparatus of the present invention;

FIG. 6 is a diagram of the structure of an apparatus for establishing an ad-hoc network of Bluetooth and wireless LAN of the present invention;

FIG. 7 is a flowchart of the steps performed by a Bluetooth-to-wireless LAN linking method of the present invention;

FIG. 8 is a flowchart of the steps performed by a wireless LAN-to-Bluetooth linking method of the present invention; and

FIG. 9 is a flowchart of the steps performed by a Bluetooth and wireless LAN ad-hoc network establishing method of the present invention.

### DETAILED DESCRIPTION OF EXEMPLARY EMBODIMENTS

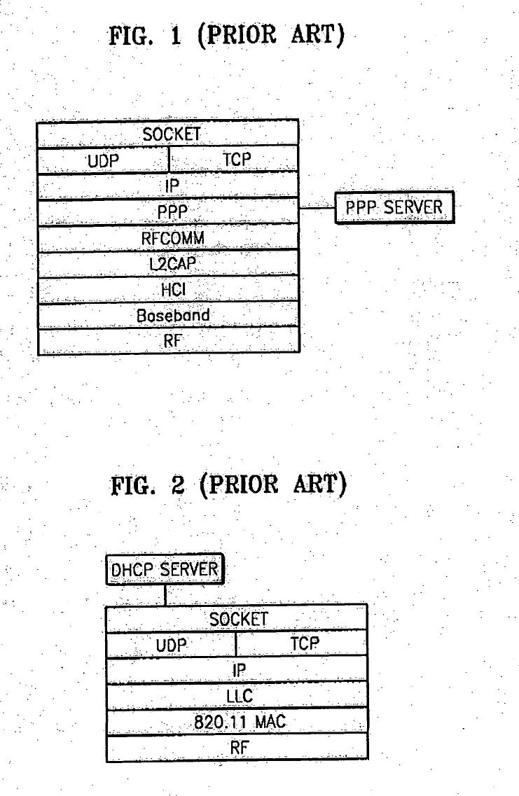

Referring to FIG. 1, a prior art Bluetooth protocol stack is constructed hierarchically from the bottom layer in order of radio frequency (RF), baseband, host controller interface (HCI), logical link control and adaptation protocol (L2CAP), RFCOMM, point-to-point protocol (PPP), Internet Protocol (IP), transmission control protocol (TCP)/user datagram protocol (UDP), and socket.

The RF layer corresponds to the physical layer of the Open Systems Interconnection (OSI) framework, which is the lowest layer in the OSI layers. The RF layer operates in the unlicensed 2.4 GHz to 2.4835 GHz industrial, scientific, and medical (ISM) band, and uses a frequency hopping signal at up to 1,600 hops/sec., which hops among 79 frequencies usually at 1 MHz intervals with 1 mW output. For modulation, Gaussian Frequency Shift Keying (G-FSK) is used and for duplex communications, a time division duplex (TDD) method is used.

Like the RF layer, the baseband layer corresponds to the physical layer that establishes a physical connection. Through the baseband layer, seven Bluetooth apparatuses are connected to one piconet. One of the seven Bluetooth apparatuses becomes a master for administration of the piconet, including generation of a frequency hopping pattern, and the remaining apparatuses are connected as slaves.

The HCI layer is an interfacing protocol between a Bluetooth module and a host. The reason why the Bluetooth standards define such an interface method as the HCI is to completely separate hardware and software such that the software module need not be replaced when a Bluetooth hardware module is replaced.

The L2CAP layer corresponds to the data link layer of the OSI, and is a protocol stack for interfacing a lower layer protocol stack with an upper layer application. The L2CAP layer plays almost the same role as the TCP layer of the Internet Protocol. The L2CAP layer is an essential layer located immediately above the HCI layer and enables the upper layer protocol or application to exchange a data packet up to 64 MB.

The RFCOMM layer is an emulator for serial communications and a protocol replacing serial communication protocols such as the RS-232C interface.

The PPP layer is a protocol needed by two computers communicating with each other through a serial interface. Particularly, personal computers connected to a server through a telephone line frequently use this protocol. For example, most Internet service providers (ISPs) provide Internet PPP access for their subscribers such that a server responds to a user request, the user can access the Internet through the server, and a response to the user request is sent back to the user by the server. The PPP uses the IP and sometimes is regarded as one of the TCP/IP protocol group. Compared to the OSI reference model, the PPP provides a data link service corresponding to the second layer of the OSI. Originally, the PPP packs TCP/IP packets of a computer and sends the packets to a server so that the packets are transmitted to the Internet. Most routers for LAN access support the PPP communications protocol. Since the PPP includes a function for compressing only the header part of a data packet, as well as an authentication protocol such as the password authentication protocol (PAP) or the challenge-handshake authentication protocol (CHAP), these functions can be used when a connection is established. Also, the PPP includes a function of an Internet protocol control protocol (IPCP) by which an access server automatically allocates an IP address to a client personal computer when a remote LAN is accessed. In a dial-up IP access in which a user accesses a server of an ISP through a public network such as a public-switched telephone network (PSTN) or an integrated services digital network (ISDN), the IPCP is generally used for the PPP access, and therefore the user does not need to obtain a global IP address. The PPP is a representative protocol for a dial-up IP access and is defined in RFC 1171.

The IP is a protocol which is used when a computer on the Internet transmits data to another computer. Each computer on the Internet, that is, each host, has at least one or more proper addresses so that the computer can be distinguished from other computers. When a user sends or receives data such as email or web pages, a message is divided into small pieces called packets. Each of these packets has the Internet addresses of a source and a destination. Any packet can be first sent to a gateway computer. The gateway computer reads the destination address and sends the packet to a neighboring gateway. Then, reading the destination address is repeated and gateways continue to send the packet until the packet arrives near to the destination address or a gateway of the domain of the destination address receives the packet. When a gateway of the domain corresponding to the destination address receives the packet, the gateway directly transfers the packet to a computer having the address of the destination. Since one message is formed with a plurality of packets, each packet may be transmitted through different paths when necessary, and packets may arrive in different order from the original transmitting order. However, the IP just delivers the packets and rearranging the packets in the different order into the original order is performed by another protocol, i.e., the TCP. The IP layer corresponds to the third layer, the network layer, of the OSI communications reference model.

The TCP is a protocol which is used together with the IP in order to transmit data in the form of a message between computers on the Internet. While the IP actually controls the delivery processing of data, the TCP traces and manages data packets. A message is divided into a plurality of small pieces for more efficient routing on the Internet, and each piece is referred to as a packet. For example, when an HTML file is transmitted to a user from a web server, the TCP program layer in the server divides the file into a plurality of packets, numbers each packet, and sends the packets to the IP program layer. Although the packets have the same destination address (IP address), the packets may be transmitted through different paths. The TCP in the other side (the client program of a user computer) reassembles the packets until the packets can be sent as a complete file to the user. The TCP corresponds to the fourth layer, the transport layer, of the OSI communications model.

The UDP is a communications protocol which provides only limited services when messages are communicated between computers on a network using the IP. The UDP is an alternative to the TCP, and when used with the IP, is also referred to as UDP/IP. Like the TCP, the UDP uses the IP so that one computer receives the actual data unit called datagram from the other computer. However, unlike the TCP, the UDP does not provide services for dividing a message into packets (datagram) and reassembling the packets in the other side, and particularly does not provide the order of arriving data packets. In order words, an application using the UDP should be able to confirm that the entire message arrives in the correct order. A network application program having less data to exchange (therefore, less messages to be reassembled) may prefer the UDP to the TCP in order to reduce processing time. Like the TCP, the UDP corresponds to the fourth layer, the transport layer, of the OSI communications model.

The socket is a communications method between a client program and a server program on a network. The socket is defined as “the end part of an access”. The socket is sometimes referred to as an application programming interface (API) and is generated and used by a series of programming requests or function calls.

FIG. 2 is a diagram of the structure of a prior art wireless LAN protocol stack.

The wireless LAN protocol stack is constructed hierarchically from the bottom layer in order of the RF, 802.11 media access control (MAC), logical link control (LLC), IP, TCP/UDP, socket, and dynamic host configuration protocol (DHCP) server.

The RF layer corresponds to the physical layer of the OSI, which is the lowest layer in the OSI model. The 802.11a standard uses a 5 GHz band and the 802.11b standard uses a 2.4 GHz band like the Bluetooth. For modulation, binary phase shift keying (BPSK), quadrature phase shift keying (QPSK), 16 quadrature amplitude modulation (QAM), or 64 QAM orthogonal frequency division multiplexing (OFDM) are used.

The 802.11 a/b MAC is a protocol by which a plurality of computers sharing an identical transmission line can efficiently use the transmission line. The 802.11 is a collection of standards for wireless LAN developed by an IEEE working group, and includes four standards, 802.11, 802.11a, 802.11b, and 802.11g, at present. In order to share a path, the four standards all use carrier sense multiple access/collision avoidance (CSMA/CA), which is an Ethernet protocol. While the 802.11b standard provides a speed of about 11 Mbps, the 802.11g standard, which is the most recently approved standard, provides a speed of up to 54 Mbps although it is provided in a relatively short distance. Since the 802.11g also operates in the 2.4 GHz band like the 802.11b, the two standards have compatibility to each other. The 802.11b standard, frequently referred to as Wi-Fi, provides backward compatibility for the 802.11. Although the modulation method traditionally used in the 802.11 standard is phase-shift keying (PSK), the modulation method employed by the 802.11b is complementary code keying (CCK), which provides a faster data transmission speed with less interference by multiple path transmission. The 802.11g standard is applied to a wireless ATM system and mainly used in an access hub. The 802.11a operates in the 5 GHz to 6 GHz wireless frequency bandwidth. The 802.11a uses the OFDM modulation so that maximum 54 Mbps data transmission speed is available. However, in the actual communications, the speed is 6 Mbps, 12 Mbps, or 24 Mbps.

The MAC is the lower layer of the two sub layers of the data link layer defined by the IEEE, and the MAC sub layer processes shared medium access problems such as token passing or determining whether or not there is a collision. In an ordinary Ethernet LAN, all computers connected to an identical LAN segment can perform communications through the third layer protocols including the TCP/IP, IPX, and APPLETALK (a trademark of Apple Computer, Inc.), based on the MAC address (corresponding to the second layer of the OSI). Since a number that is unique only to one product in the world is allocated as a MAC address when the product is manufactured and shipped by a device manufacturer, the MAC address can be referred to as an address from the viewpoint of hardware.

The LLC is the upper layer of the two sub layers of the data link layer defined by the IEEE. The LLC sub layer processes error control, flow control, frame processing, MAC sub layer addressing, etc. This protocol includes both a connectionless type and a connection-oriented type.

Since the IP, the TCP/UDP, and the socket that are upper layers of the layers in the wireless LAN protocol stack described above are in common with the Bluetooth, their explanation will be omitted. The DHCP of the application layer is a protocol which enables network administrators to centrally manage and allocate IP addresses on a network in an organization. In the TCP/IP protocol of the Internet, each computer should have a unique IP address in order to access the Internet. When computer users access the Internet in an organization, an IP address should be allocated to each computer. When the DHCP is not used, an IP address should be input manually for each computer, and if computers are moved to a location belonging to another part of the network, new IP addresses should be input. In the DHCP, a network administrator centrally manages and allocates an IP address, and when a computer is connected in a different location of the network, a new IP address can automatically be sent to the computer.

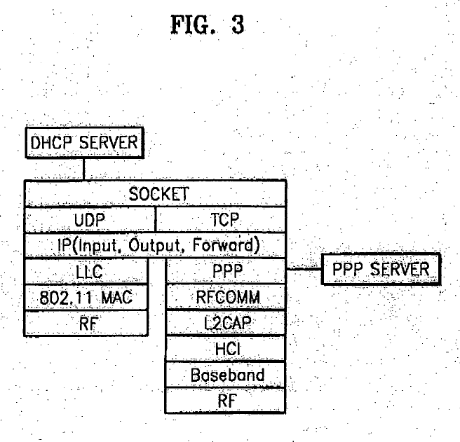

FIG. 3 is a diagram of the structure of a mixed protocol stack of Bluetooth and wireless LAN of the present invention.

The mixed protocol stack of Bluetooth and wireless LAN has the layers common to the Bluetooth stack protocol and the wireless LAN protocol stack, as upper layers, and the layers different in the two protocol stacks, as lower layers. The upper layers are stacked in order of the IP, the TCP or UDP, and the socket. The lower layers include the Bluetooth protocol stack part and the wireless LAN protocol stack part. In the Bluetooth protocol stack part, layers are stacked in order of the RF, the baseband, the HCI, the L2CAP, the RFCOMM, and the PPP from the bottom. In the wireless LAN protocol stack part, layers are stacked in order of the RF, the 802.11 MAC, and the LLC from the bottom.

First, a process for converting a Bluetooth signal into a wireless LAN signal, when the Bluetooth signal is received, will now be explained. For a Bluetooth signal, the RF layer corresponding to the lowest layer in the OSI layers operates in the 2.4 GHz band and uses a frequency hopping signal at up to 1,600 hops/sec., which hops among 79 frequencies usually at 1 MHz intervals and with 1 mW output. For modulation, Gaussian frequency shift keying (G-FSK) is used and for duplex communications, a time division duplex (TDD) method is used.

When the received Bluetooth signal leaves the RF layer, the signal passes to the baseband layer that is the upper layer of the RF layer. Like the RF layer, the baseband layer corresponds to the physical layer for physical connection. In the baseband layer, seven Bluetooth apparatuses are connected to one piconet, and one among the seven apparatuses becomes a master for administration of the piconet, including generation of a frequency hopping pattern, and the remaining apparatuses are connected as slaves.

When the received Bluetooth signal leaves the baseband layer, the signal passes to the HCI layer that is the upper layer of the baseband layer. The HCI layer interfaces a Bluetooth module with a host. When the received Bluetooth signal leaves the HCI layer, the signal passes to the L2CAP layer that is the upper layer of the HCI layer. The L2CAP layer corresponds to the data link layer and interfaces the lower protocol stack with the upper application. The L2CAP layer performs a function almost the same as the TCP layer of the IP. The L2CAP layer is an essential layer located immediately above the HCI layer and enables the upper layer protocol or application to exchange a data packet of up to 64 MB.

When the received Bluetooth signal leaves the L2CAP layer, the signal passes to the RFCOMM layer that is the upper layer of the L2CAP layer. The RFCOMM layer is an emulator for serial communications and replaces serial communication protocols such as the RS-232C interface. When the received Bluetooth signal leaves the RFCOMM layer, the signal passes to the PPP layer that is the upper layer of the RFCOMM layer. The PPP layer is a protocol needed by two computers communicating with each other through a serial interface. Most ISPs provide Internet PPP access for their subscribers such that a server responds to a user request, the user can access the Internet through the server, and a response to the user request is sent back to the user by the server. The PPP uses the IP and sometimes is regarded as one of the TCP/IP protocol group. Compared to the OSI reference model, the PPP provides a data link service corresponding to the second layer of the OSI. Originally, the PPP packs TCP/IP packets of a computer and sends the packets to a server so that the packets are transmitted to the Internet. Also, the PPP includes a function of an Internet protocol control protocol (IPCP) by which an access server automatically allocates an IP address to a client personal computer when a remote LAN is accessed. In a dial-up IP access in which a user accesses a server of an ISP through a public network such as a public-switched telephone network (PSTN) or an integrated services digital network (ISDN), the IPCP is generally used for the PPP access, and therefore the user does not need to obtain a global IP address. The present invention establishes an ad-hoc network by using the IPCP.

When the received Bluetooth signal leaves the PPP layer, the signal passes to the IP layer that is the upper layer of the PPP layer. The IP is a protocol which is used when a computer on the Internet transmits data to another computer. Each computer on the Internet, that is, each host, has at least one or more proper addresses so that the computer can be distinguished from other computers. When a user sends or receives data such as email or web pages, a message is divided into small pieces called packets. Each of these packets has the Internet addresses of a source and a destination. Any packet can be first sent to a gateway computer. The gateway computer reads the destination address and sends the packet to a neighboring gateway. Then, reading the destination address is repeated and gateways continue to send the packet until the packet arrives near to the destination address or a gateway of the domain of the destination address receives the packet. When a gateway of the domain corresponding to the destination address receives the packet, the gateway directly transfers the packet to a computer having the address of the destination. Since one message is formed with a plurality of packets, each packet may be transmitted through different paths when necessary, and packets may arrive in different order from the original transmitting order. However, the IP just delivers the packets and rearranging the packets into their original order is performed by another protocol, i.e., the TCP.

Since the IP layer is common with the wireless LAN, the IP packet passing through the Bluetooth protocol stack is forwarded to the wireless LAN protocol stack. Here, the IP packet may have an IPv4 format or IPv6 format. The IP packet forwarded to the wireless LAN protocol stack passes to the LLC layer that is the lower layer of the IP layer.

The LLC layer is the upper layer of the two sub layers of the data link layer (MAC, LLC) defined by the IEEE. The LLC sub layer processes error control, flow control, frame processing, MAC sub layer addressing, etc. This protocol includes both a connectionless type and a connection-oriented type. The signal that passes through the LLC layer passes to the 802.11 MAC layer.

The 802.11 MAC is a protocol by which a plurality of computers sharing an identical transmission line can efficiently use the transmission line. The 802.11 is a collection of standards for wireless LAN developed by an IEEE working group, and includes four standards, 802.11, 802.11a, 802.11b, and 802.11g, at present. In order to share a path, the four standards all use carrier sense multiple access/collision avoidance (CSMA/CA), which is an Ethernet protocol. The MAC is the lower layer of the two sub layers of the data link layer defined by the IEEE, and the MAC sub layer processes shared medium access problems such as token passing or determining whether or not there is a collision. In the Ethernet that is an ordinary LAN, all computers connected to an identical LAN segment can perform communications through the third layer protocols such as the TCP/IP, based on the MAC address. Since a number unique only to one product in the world is allocated as a MAC address, when the product is manufactured and shipped by a device manufacturer, the MAC address can be referred to as an address from the viewpoint of hardware. The signal that passes through the 802.11 a/b MAC layer passes to the RF layer.

The RF layer corresponds to the physical layer that is the lowest layer of the OSI. The 802.11a operates in the 5 GHz band, and like the Bluetooth, the 802.11b operates in the 2.4 GHz band. While the 802.11b standard provides a speed of about 11 Mbps, the more recently approved 802.11g standard provides a speed of up to 54 Mbps although it is provided in a relatively short distance. Since the 802.11g also operates in the 2.4 GHz band like the 802.11b, the two standards have compatibility to each other. The 802.11b standard, which is frequently referred to as Wi-Fi, provides backward compatibility for the 802.11. Although the modulation method traditionally used in the 802.11 standard is phase-shift keying (PSK), the modulation method employed by the 802.11b is complementary code keying (CCK), which provides a faster data transmission speed with less interference by multiple path transmission. The 802.11g standard is applied to a wireless ATM system and mainly used in an access hub. The 802.11a operates in the 5 GHz to 6 GHz wireless frequency bandwidth. The 802.11a uses the OFDM modulation so that a maximum 54 Mbps data transmission speed is available. However, in actual communications, the speed is 6 Mbps, 12 Mbps, or 24 Mbps. The signal passing through the protocol stack as described above becomes a wireless LAN signal complying with the IEEE 802.11 standard and is transmitted to other wireless LAN terminals. Accordingly, an environment is established in which a Bluetooth terminal is linked to a wireless LAN terminal through a Bluetooth wireless LAN compound terminal and communications between the terminals are enabled.

Next, when a wireless LAN signal is received, a process for converting the wireless LAN signal into a Bluetooth signal is the reverse of the process described above.

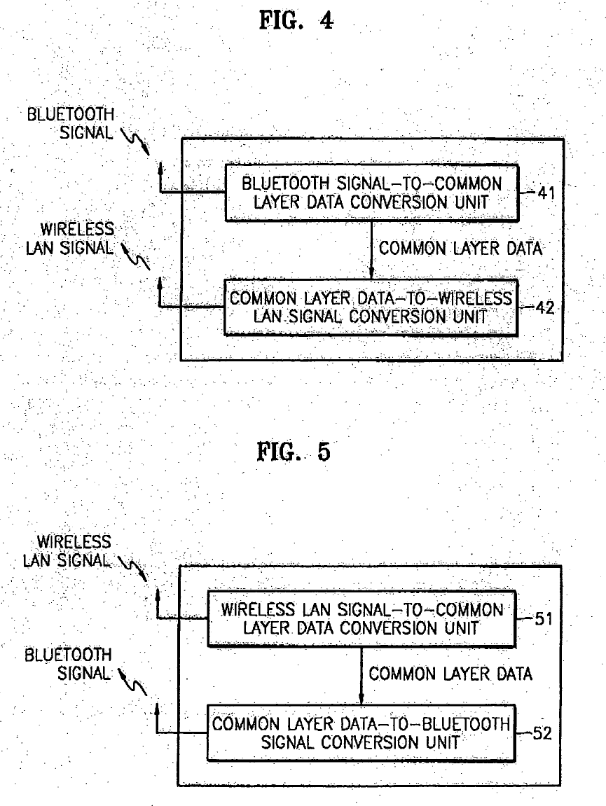

FIG. 4 is a diagram of the structure of a Bluetooth-to-wireless LAN linking apparatus of the present invention.

The Bluetooth-to-wireless LAN linking apparatus comprises a Bluetooth signal-to-common layer data conversion unit 41 and a common layer data-to-wireless LAN signal conversion unit 42.

The Bluetooth signal-to-common layer data conversion unit 41 receives a Bluetooth signal and converts the received Bluetooth signal into common layer data. The common layer data is the IP data in the network layer that is the lowest layer common to the Bluetooth protocol stack and the wireless LAN protocol stack. Although the common layer data may be the data of the upper layers such as the TCP layer, UDP layer and socket layer, the IP data is determined as the common layer data, considering the efficiency of a path passing through the protocol stack. The Bluetooth signal-to-common layer data conversion unit 41 comprises a Bluetooth signal receiving unit which receives the Bluetooth signal from an arbitrary Bluetooth terminal, and a common layer data conversion unit which sends the received Bluetooth signal to the common layers of the Bluetooth protocol stack and the wireless LAN protocol stack and converts the signal to the common layer data. The common layer data conversion unit converts the Bluetooth signal into IP data that is the common layer data, by passing the received Bluetooth signal from the RF layer, which is the lowest layer of the Bluetooth protocol stack, through the baseband layer, the HCI layer, the L2CAP layer, the RFCOMM layer, and the PPP layer in turn, to the IP layer, and if the signal arrives at the IP layer, extracting the IP data in the IP layer.

The common layer data-to-wireless LAN signal conversion unit 42 converts the common layer data into a wireless LAN signal and transmits the signal. The common layer data-to-wireless LAN signal conversion unit 42 comprises a wireless LAN signal conversion unit which passes the common layer data to the lowest layer of the wireless LAN protocol stack and converts the data into a wireless LAN signal, and a wireless LAN signal transmission unit which transmits the wireless LAN signal to a wireless LAN terminal having an IP address included in the wireless LAN signal. The wireless LAN signal conversion unit forwards the IP data that is the common layer data, from the Bluetooth protocol stack to the wireless LAN protocol stack, and generates a wireless LAN signal complying with the IEEE standard, by passing the forwarded IP data through the lower layers of the wireless LAN protocol stack in order of the LLC layer, the 802.11 MAC layer, and the RF layer. In the protocol of the wireless LAN signal, a destination address is in the IP header part of the IP protocol and the wireless LAN signal is transmitted to a wireless LAN terminal having an IP address the same as the destination address.

FIG. 5 is a diagram of the structure of a wireless LAN-to-Bluetooth linking apparatus of the present invention.

The wireless LAN-to-Bluetooth linking apparatus comprises a wireless LAN signal-to-common layer data conversion unit 51 and a common layer data-to-Bluetooth signal conversion unit 52.

The wireless LAN signal-to-common layer data conversion unit 51 receives a wireless LAN signal and converts the received wireless LAN signal into common layer data. The common layer data is the IP data in the network layer that is the lowest common layer of the Bluetooth protocol stack and the wireless LAN protocol stack. The wireless LAN signal-to-common layer data conversion unit comprises a wireless LAN signal receiving unit which receives the wireless LAN signal from an arbitrary wireless LAN terminal, and a common layer data conversion unit which sends the received wireless LAN signal to the common layers of the Bluetooth protocol stack and the wireless LAN protocol stack and converts the signal to the common layer data. The common layer data conversion unit converts the wireless LAN signal into the common layer data, by passing the received wireless LAN signal from the RF layer that is the lowest layer of the wireless LAN protocol, through the 802.11 MAC layer, and the LLC layer in turn, to the IP layer, and if the signal arrives at the IP layer, extracting the IP data that is the common layer data in the IP layer.

The common layer data-to-Bluetooth signal conversion unit 52 converts the common layer data into a Bluetooth signal and transmits the signal. The common layer data-to-Bluetooth signal conversion unit 52 comprises a Bluetooth signal conversion unit which passes the common layer data to the lowest layer of the Bluetooth protocol stack and converts the data into a Bluetooth signal, and a Bluetooth signal transmission unit which transmits the Bluetooth signal to a Bluetooth terminal having an IP address included in the Bluetooth signal. The Bluetooth signal conversion unit forwards the IP data that is the common layer data, from the wireless LAN protocol stack to the IP layer of the Bluetooth protocol stack, and generates a Bluetooth signal, by passing the forwarded IP data through the lower layers in order of the PPP layer, the RFCOMM layer, the L2CAP layer, the HCI layer, the baseband layer, and the RF layer.

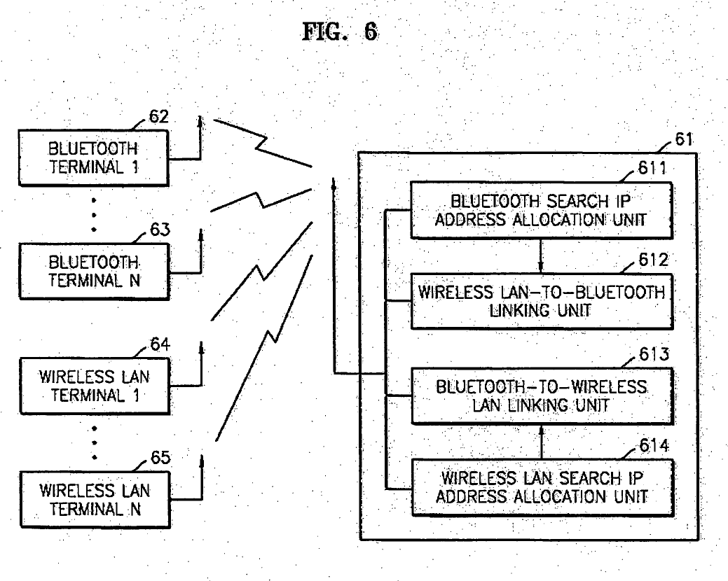

FIG. 6 is a diagram of the structure of an apparatus 61 for establishing an ad-hoc network of Bluetooth and wireless LAN of the present invention.

The apparatus 61 for establishing an ad-hoc network of Bluetooth and wireless LAN comprises a Bluetooth search IP address allocation unit 611, a wireless LAN search IP address allocation unit 614, a Bluetooth-to-wireless LAN linking unit 613, and a wireless LAN-to-Bluetooth linking unit 612.

The Bluetooth search IP address allocation unit 611 receives a search signal from an arbitrary Bluetooth terminal 62 or 63, accesses the Bluetooth terminal and allocates an IP address to the terminal. The Bluetooth search IP address allocation unit 611 comprises a Bluetooth search unit which receives a signal for searching for an arbitrary wireless LAN terminal from an arbitrary Bluetooth terminal 62 or 63 within a range for communications, and a Bluetooth IP address allocation unit which accesses the Bluetooth terminal 62 or 63 and allocates an IP address through a PPP server. A process in which an arbitrary Bluetooth terminal 62 or 63 tries to search and access the Bluetooth wireless LAN compound terminal is performed as in the prior art. The PPP server has the IPCP function by which an access server automatically allocates an IP address to a client personal computer when a remote LAN is accessed. The present invention establishes an ad-hoc network, by using the IPCP function. That is, an arbitrary Bluetooth terminal using the service discovery protocol (SDP) checks whether or not there is a LAN access profile in the Bluetooth wireless LAN compound terminal. Since there is a LAN access profile in the Bluetooth wireless LAN compound terminal, PPP access to the compound terminal by the Bluetooth terminal is performed according to a procedure described in the profile. The PPP server operates in the Bluetooth wireless LAN compound terminal and allocates an IP address to the Bluetooth terminal which tries the access.

The wireless LAN search IP address allocation unit 614 receives a search signal from an arbitrary wireless LAN terminal 64 or 65, accesses the wireless LAN compound terminal, and allocates an IP address. The wireless LAN search IP address allocation unit 614 comprises a wireless LAN search unit which receives a signal for searching for an arbitrary Bluetooth terminal from an arbitrary wireless LAN terminal 64 or 65 within a range for communications, and a wireless LAN IP address allocation unit which accesses the wireless LAN terminal 64 or 65 and dynamically allocates an IP address through a DHCP server. A process in which an arbitrary wireless LAN terminal 64 or 65 tries to search and access the Bluetooth wireless LAN compound terminal is performed as in the prior art. The DHCP server enables a network administrator to centrally manage and allocate IP addresses and to send a new IP address to a computer when the computer is connected in a different location of the network. The DHCP is based on a concept of “rent” in which a given IP address for a computer is effective only for a predetermined period. The rent term may vary depending on how long a user needs the Internet access in a predetermined location. Even when there are more computers than the number of available IP addresses, the DHCP can dynamically reconstruct a network by shortening the rent time of an IP address. In the present invention, IP addresses are dynamically provided by the DHCP server such that an ad-hoc network is established.

The Bluetooth-to-wireless LAN linking unit 613 receives a Bluetooth signal from an arbitrary Bluetooth terminal 62 or 63, converts the signal into common layer data, converts the common layer data into a wireless LAN signal, and transmits the wireless LAN signal to a wireless LAN terminal 64 or 65 to which an IP address included in the wireless LAN signal is allocated. The common layer data is the IP data in the network layer that is the lowest common layer of the Bluetooth protocol stack and the wireless LAN protocol stack. The Bluetooth-to-wireless LAN linking unit 613 comprises a Bluetooth signal-to-common layer data conversion unit which receives a Bluetooth signal from the Bluetooth terminal 62 or 63, sends the received Bluetooth signal to the common layer of the Bluetooth protocol stack and the wireless LAN protocol stack, and converts the signal to common layer data, and a common layer data-to-wireless LAN conversion unit which sends the common layer data to the lowest layer of the wireless LAN protocol stack and, converts the common layer data into a wireless LAN signal, and transmits the converted wireless LAN signal to the wireless LAN terminal 64 or 65 to which an IP address included in the wireless LAN signal corresponds. The Bluetooth-to-wireless LAN linking unit 613 has an IP address, and if the IP address included in a Bluetooth signal from an arbitrary Bluetooth terminal 62 or 63 is the IP address of the Bluetooth-to-wireless LAN linking unit 613, the Bluetooth-to-wireless LAN linking unit 613 receives the Bluetooth signal. The received Bluetooth signal is converted into the wireless LAN signal and the wireless LAN signal is transmitted to a wireless LAN terminal 64 or 65 to which an IP address corresponding to an IP address included in the wireless LAN signal is allocated. Accordingly, the Bluetooth-to-wireless LAN linking unit 613 plays the role of a router which sets a route between the Bluetooth terminal 62 or 63 and the wireless LAN terminal 64 or 65.

The wireless LAN-to-Bluetooth linking unit 612 receives a wireless LAN signal from an arbitrary wireless LAN terminal 64 or 65, converts the signal into common layer data, converts the common layer data into a Bluetooth signal, and transmits the Bluetooth signal to a Bluetooth terminal 62 or 63 to which an IP address included in the converted Bluetooth signal is allocated. The wireless LAN-to-Bluetooth linking unit 612 comprises a wireless LAN signal-to-common layer data conversion unit which receives a wireless LAN signal from an arbitrary wireless LAN terminal, sends the received wireless LAN signal to the common layer of the Bluetooth protocol stack and the wireless LAN protocol stack, and converts the signal to the common layer data, and a common layer data-to-Bluetooth signal conversion unit which sends the common layer data to the lowest layer of the Bluetooth protocol stack, converts the common layer data into a Bluetooth signal, and transmits the Bluetooth signal to a Bluetooth terminal 62 or 63 to which an IP address included in the converted Bluetooth signal is allocated. The wireless LAN-to-Bluetooth linking unit 612 has an IP address, and if the IP address included in a wireless LAN signal from an arbitrary wireless LAN terminal 64 or 65 is the IP address of the wireless LAN-to-Bluetooth linking unit 612, the wireless LAN-to-Bluetooth linking unit 612 receives the wireless LAN signal. The received wireless LAN signal is converted into the Bluetooth signal and the Bluetooth signal is transmitted to a Bluetooth terminal 62 or 63 to which an IP address corresponding to an IP address included in the Bluetooth signal is allocated. Accordingly, the wireless LAN-to-Bluetooth linking unit 612 plays the role of a router which sets a route between the wireless LAN terminal 64 or 65 and the Bluetooth terminal 62 or 63. Thus, when a wireless LAN terminal 64 or 65 desires to communicate with a Bluetooth terminal 62 or 63 using an IP address allocated to the Bluetooth terminal 62 or 63, the wireless LAN terminal 64 or 65 sets its own IP address as a source address, sets the IP address of the Bluetooth terminal as a destination address, and transmits a wireless LAN signal. The wireless LAN signal is received by a Bluetooth wireless LAN compound terminal, and the wireless LAN signal is sent to the IP layer of the Bluetooth wireless LAN compound terminal. In the IP layer, it is determined where the signal should be transmitted based on the IP address. Since the destination address of the IP data is the IP address of the Bluetooth terminal, the IP data is transmitted to the Bluetooth module through the PPP. The Bluetooth terminal receives this data through the Bluetooth module.

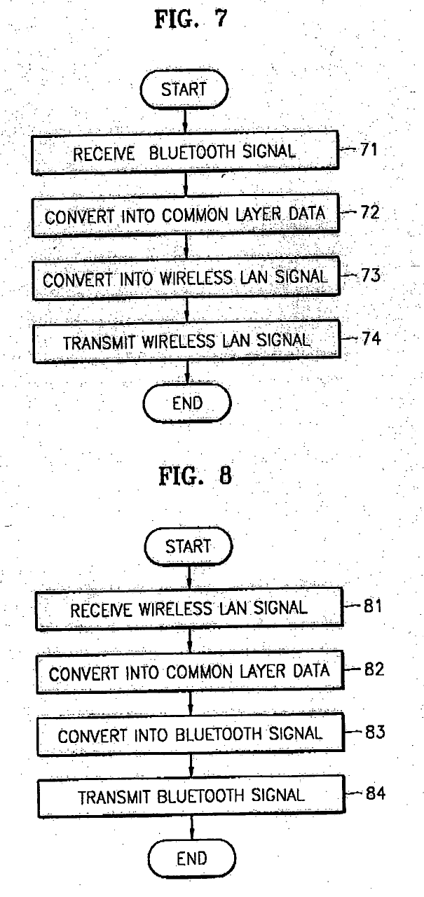

FIG. 7 is a flowchart of the steps performed by a Bluetooth-to-wireless LAN linking method of the present invention.

First, a Bluetooth signal is received in step 71, and the received Bluetooth signal is converted into common layer data in step 72. That is, the Bluetooth signal from an arbitrary Bluetooth terminal is received in the step 71, and the received Bluetooth signal is sent to the common layer of the Bluetooth protocol stack and the wireless LAN protocol stack and converted into the common layer data in the step 72. The common layer data is the IP data in the network layer that is the lowest common layer of the Bluetooth protocol stack and the wireless LAN protocol stack.

Then, the common layer data is converted into a wireless LAN signal in step 73, and the signal is transmitted in step 74. That is, the common layer data is sent to the lowest layer of the wireless LAN protocol stack and is converted into a wireless LAN signal in the step 73, and the wireless LAN signal is transmitted to a wireless LAN terminal having the IP address included in the wireless LAN signal in the step 74.

FIG. 8 is a flowchart of the steps performed by a wireless LAN-to-Bluetooth linking method of the present invention.

First, a wireless LAN signal is received in step 81, and the received wireless LAN signal is converted into common layer data in step 82. The common layer data is the IP data in the network layer that is the lowest common layer of the Bluetooth protocol stack and the wireless LAN protocol stack. That is, the wireless LAN signal from an arbitrary wireless LAN terminal is received in the step 81, and the received wireless LAN signal is sent to the common layer of the Bluetooth protocol stack and the wireless LAN protocol stack and the signal is converted into the common layer data in the step 82.

Then, the common layer data is converted into a Bluetooth signal in step 83, and the signal is transmitted in step 84. That is, the common layer data is sent to the lowest layer of the Bluetooth protocol stack and is converted into a Bluetooth signal in the step 83, and the Bluetooth signal is transmitted to a Bluetooth terminal having the IP address included in the Bluetooth signal in the step 84.

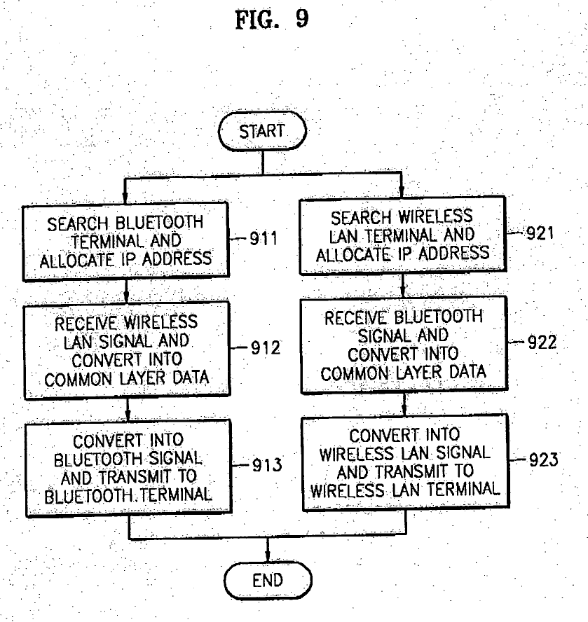

FIG. 9 is a flowchart of the steps performed by a Bluetooth and wireless LAN ad-hoc network establishing method of the present invention.

First, a search signal from an arbitrary Bluetooth terminal is received, the Bluetooth terminal is accessed, and an IP address is allocated in step 911. That is, a signal for searching for an arbitrary wireless LAN terminal from an arbitrary Bluetooth terminal within a range for communications is received, the Bluetooth terminal is accessed, and an IP address is dynamically allocated through a PPP server.

Then, a wireless LAN signal from an arbitrary wireless LAN terminal is received and the signal is converted into common layer data in step 912, and the common layer data is converted into a Bluetooth signal and the Bluetooth signal is transmitted to a Bluetooth terminal to which an IP address included in the converted Bluetooth signal is allocated in step 913. The common layer data is the IP data in the network layer that is the lowest common layer of the Bluetooth protocol stack and the wireless LAN protocol stack. That is, a wireless LAN signal from an arbitrary wireless LAN terminal is received, the received wireless LAN signal is sent to the common layer of the Bluetooth protocol stack and the wireless LAN protocol stack, and the wireless LAN signal is converted into the common layer data in the step 912. The common layer data is sent to the lowest layer of the Bluetooth protocol stack and is converted into a Bluetooth signal, and the converted Bluetooth signal is transmitted to a Bluetooth terminal to which an IP address included in the Bluetooth signal is allocated in the step 913.

Then, a search signal from an arbitrary wireless LAN terminal is received, the wireless LAN terminal is accessed, and an IP address is allocated in step 921. That is, a signal for searching for a Bluetooth terminal from an arbitrary wireless LAN terminal within a range for communications is received, the wireless LAN terminal is accessed, and an IP address is dynamically allocated through a DHCP server in the step 921.

Then, a Bluetooth signal from an arbitrary Bluetooth terminal is received and is converted into common layer data in step 922. The common layer data is converted into a wireless LAN signal and the wireless LAN signal is transmitted to a wireless LAN terminal to which an IP address included in the converted wireless LAN signal is allocated in step 923. That is, a Bluetooth signal from the Bluetooth terminal is received, is sent to the common layer of the Bluetooth protocol stack and the wireless LAN protocol stack, and is converted into the common layer data in the step 922. The common layer data is sent to the lowest layer of the wireless LAN protocol stack and is converted into a wireless LAN signal, and the wireless LAN signal is transmitted to a wireless LAN terminal to which an IP address included in the converted wireless LAN signal is allocated in the step 923.

The present invention may be embodied in a code, which can be read by a computer, on a computer readable recording medium. The computer readable recording medium includes all kinds of recording apparatuses on which computer readable data are stored.

For example, the computer readable recording media includes storage media such as magnetic storage media (e.g., ROM's, floppy disks, hard disks, etc.), optically readable media (e.g., CD-ROMs, DVDs' etc.) and carrier waves (e.g., transmissions over the Internet).

While various exemplary embodiments have been described and illustrated herein, the present invention is not meant to be limited to these exemplary embodiments, and it is apparent that variations and modifications by those skilled in the art can be effected within the spirit and scope of the present invention, as defined in the appended claims. Therefore, the scope of the present invention is not determined by the above description but by the accompanying claims.

According to the present invention, by linking a Bluetooth terminal and a wireless LAN terminal, communications between the Bluetooth terminal and the wireless LAN terminal that use different technologies are enabled. Also, by connecting a plurality of Bluetooth terminals and a plurality of wireless LAN terminals, an ad-hoc network between the Bluetooth terminals and the wireless LAN terminals that use different technologies is established.

What is claimed is:

1. A Bluetooth-to-wireless local area network (LAN) linking apparatus comprising:
a Bluetooth signal-to-common layer data conversion unit which receives a Bluetooth signal and converts the Bluetooth signal to common layer data; and
a common layer data-to-wireless LAN signal conversion unit which converts the common layer data into a wireless LAN signal and transmits the wireless LAN signal.

2. The apparatus of claim 1, wherein the common layer data is Internet protocol (IP) data in a network layer that is the lowest common layer of a Bluetooth protocol stack and a wireless LAN protocol stack.

3. The apparatus of claim 1, wherein the Bluetooth signal-to-common layer data conversion unit comprises:
a Bluetooth signal receiving unit which receives the Bluetooth signal from an arbitrary Bluetooth terminal; and
a common layer data conversion unit which sends the received Bluetooth signal to a common layer of a Bluetooth protocol stack and a wireless LAN protocol stack and converts the sent Bluetooth signal into common layer data.

4. The apparatus of claim 1, wherein the common layer data-to-wireless LAN signal conversion unit comprises:
a wireless LAN signal conversion unit which sends the common layer data to the lowest layer of a wireless LAN protocol stack and converts the data into a wireless LAN signal; and
a wireless LAN signal transmission unit which transmits the wireless LAN signal to a wireless LAN terminal having an IP address included in the wireless LAN signal.

5. A wireless LAN-to-Bluetooth linking apparatus comprising:
a wireless LAN signal-to-common layer data conversion unit which receives a wireless LAN signal and converts the received wireless LAN signal to common layer data; and
a common layer data-to-Bluetooth signal conversion unit which converts the common layer data into a Bluetooth signal and transmits the Bluetooth signal.

6. The apparatus of claim 5, wherein the common layer data is IP data in a network layer that is the lowest common layer of a Bluetooth protocol stack and a wireless LAN protocol stack.

7. The apparatus of claim 5, wherein the wireless LAN signal-to-common layer data conversion unit comprises:
a wireless LAN signal receiving unit which receives the wireless LAN signal from an arbitrary wireless LAN terminal; and
a common layer data conversion unit which sends the received wireless LAN signal to a common layer of a Bluetooth protocol stack and a wireless LAN protocol stack and converts the sent wireless LAN signal into common layer data.

8. The apparatus of claim 5, wherein the common layer data-to-Bluetooth signal conversion unit comprises:
a Bluetooth signal conversion unit which sends the common layer data to the lowest layer of a Bluetooth protocol stack and converts the sent common layer data into a Bluetooth signal; and
a Bluetooth signal transmission unit which transmits the Bluetooth signal to a Bluetooth terminal having an IP address included in the Bluetooth signal.

9. An apparatus for establishing an ad-hoc network of Bluetooth and wireless LAN comprising:
a Bluetooth search IP address allocation unit which receives a search signal from an arbitrary Bluetooth terminal, accesses the Bluetooth terminal, and allocates an IP address to the accessed Bluetooth terminal;
a wireless LAN search IP address allocation unit which receives a search signal from an arbitrary wireless LAN terminal, accesses the wireless LAN terminal, and allocates an IP address to the accessed wireless LAN terminal;
a Bluetooth-to-wireless LAN linking unit which receives a Bluetooth signal from an arbitrary Bluetooth terminal, converts the received Bluetooth signal into common layer data, converts the common layer data into a wireless LAN signal, and transmits the wireless LAN signal to a wireless LAN terminal to which an IP address included in the wireless LAN signal is allocated; and
a wireless LAN-to-Bluetooth linking unit which receives a wireless LAN signal from an arbitrary wireless LAN terminal, converts the received wireless LAN signal into common layer data, converts the common layer data into a Bluetooth signal, and transmits the Bluetooth signal to a Bluetooth terminal to which an IP address included in the Bluetooth signal is allocated.

10. The apparatus of claim 9, wherein the common layer data is IP data in a network layer that is the lowest common layer of a Bluetooth protocol stack and a wireless LAN protocol stack.

11. The apparatus of claim 9, wherein the Bluetooth search IP address allocation unit comprises:
a Bluetooth search unit which receives a search signal from an arbitrary Bluetooth terminal within a range for communications; and
a Bluetooth IP address allocation unit which accesses the Bluetooth terminal and dynamically allocates an IP address to the accessed Bluetooth terminal through a PPP server.

12. The apparatus of claim 9, wherein the wireless LAN search IP address allocation unit comprises:
a wireless LAN search unit which receives a search signal from an arbitrary wireless LAN terminal within a range for communications; and
a wireless LAN IP address allocation unit which accesses the wireless LAN terminal and dynamically allocates an IP address to the accessed wireless LAN terminal through a dynamic host configuration protocol (DHCP) server.

13. The apparatus of claim 9, wherein the Bluetooth-to-wireless LAN linking unit comprises:
a Bluetooth signal-to-common layer data conversion unit which receives a Bluetooth signal from the Bluetooth terminal, sends the received Bluetooth signal to a common layer of a Bluetooth protocol stack and a wireless LAN protocol stack, and converts the sent Bluetooth signal to common layer data; and
a common layer data-to-wireless LAN conversion unit which sends the common layer data to the lowest layer of the wireless LAN protocol stack, converts the common layer data into a wireless LAN signal, and transmits the converted wireless LAN signal to the wireless LAN terminal to which an IP address included in the wireless LAN signal is allocated.

14. The apparatus of claim 9, wherein the wireless LAN-to-Bluetooth linking unit comprises:
a wireless LAN signal-to-common layer data conversion unit which receives a wireless LAN signal from an arbitrary wireless LAN terminal, sends the received wireless LAN signal to a common layer of a Bluetooth protocol stack and a wireless LAN protocol stack, and converts the sent wireless LAN signal to the common layer data; and
a common layer data-to-Bluetooth signal conversion unit which sends the common layer data to the lowest layer of the Bluetooth protocol stack, converts the common layer data into a Bluetooth signal, and transmits the Bluetooth signal to a Bluetooth terminal to which an IP address included in the converted Bluetooth signal is allocated.

15. A Bluetooth-to-wireless LAN linking method comprising;
(a) receiving a Bluetooth signal and converting the Bluetooth signal to common layer data; and
(b) converting the common layer data into a wireless LAN signal and transmitting the wireless LAN signal.

16. The method of claim 15, wherein the common layer data is IP data in a network layer that is the lowest common layer of a Bluetooth protocol stack and a wireless LAN protocol stack.

17. The method of claim 15, wherein the step (a) comprises:
(a1) receiving the Bluetooth signal from an arbitrary Bluetooth terminal; and
(a2) sending the received Bluetooth signal to a common layer of a Bluetooth protocol stack and a wireless LAN protocol stack and converting the sent Bluetooth signal into common layer data.

18. The method of claim 15, wherein the step (b) comprises:
(b1) sending the common layer data to the lowest layer of a wireless LAN protocol stack and converting the sent common layer data into a wireless LAN signal; and
(b2) transmitting the wireless LAN signal to a wireless LAN terminal having an IP address included in the wireless LAN signal.

19. A wireless LAN-to-Bluetooth linking method comprising;
(a) receiving a wireless LAN signal and converting the received wireless LAN signal into common layer data; and
(b) converting the common layer data into a Bluetooth signal and transmitting the Bluetooth signal.

20. The method of claim 19, wherein the common layer data is IP data in a network layer that is the lowest common layer of a Bluetooth protocol stack and a wireless LAN protocol stack.

21. The method of claim 19, wherein the step (a) comprises:
(a1) receiving the wireless LAN signal from an arbitrary wireless LAN terminal; and
(a2) sending the received wireless LAN signal to a common layer of a Bluetooth protocol stack and a wireless LAN protocol stack and converting the sent wireless LAN signal into common layer data.

22. The method of claim 19, wherein the step (b) comprises:
(b1) sending the common layer data to the lowest layer of a Bluetooth protocol stack and converting the data into a Bluetooth signal; and
(b2) transmitting the Bluetooth signal to a Bluetooth terminal having an IP address included in the Bluetooth signal.

23. A method for establishing an ad-hoc network of Bluetooth and wireless LAN comprising:
(a) receiving a search signal from an arbitrary Bluetooth terminal, accessing the Bluetooth terminal, and allocating an IP address to the accessed Bluetooth terminal;
(b) receiving a search signal from an arbitrary wireless LAN terminal, accessing the wireless LAN terminal, and allocating an IP address to the accessed wireless LAN terminal;
(c) receiving a Bluetooth signal from an arbitrary Bluetooth terminal, converting the received Bluetooth signal into common layer data, converting the common layer data into a wireless LAN signal, and transmitting the wireless LAN signal to a wireless LAN terminal to which an IP address included in the wireless LAN signal is allocated; and
(d) receiving a wireless LAN signal from an arbitrary wireless LAN terminal, converting the received wireless LAN signal into common layer data, converting the common layer data into a Bluetooth signal, and transmitting the Bluetooth signal to a Bluetooth terminal to which an IP address included in the Bluetooth signal is allocated.

24. The method of claim 23, wherein the common layer data is IP data in a network layer that is the lowest common layer of a Bluetooth protocol stack and a wireless LAN protocol stack.

25. The method of claim 23, wherein the step (a) comprises:
(a1) receiving a search signal from an arbitrary Bluetooth terminal within a range for communications; and
(a2) accessing the Bluetooth terminal and dynamically allocating an IP address to the accessed Bluetooth terminal through a PPP server.

26. The method of claim 23, wherein the step (b) comprises:
(b1) receiving a search signal from an arbitrary wireless LAN terminal within a range for communications; and
(b2) accessing the wireless LAN terminal and dynamically allocating an IP address to the accessed wireless LAN terminal through a DHCP server.

27. The method of claim 23, wherein the step (c) comprises:
(c1) receiving a Bluetooth signal from the Bluetooth terminal, sending the received Bluetooth signal to a common layer of a Bluetooth protocol stack and a wireless LAN protocol stack, and converting the sent Bluetooth signal into common layer data; and
(c2) sending the common layer data to the lowest layer of the wireless LAN protocol stack, converting the common layer data into a wireless LAN signal, and transmitting the converted wireless LAN signal to the wireless LAN terminal to which an IP address included in the wireless LAN signal is allocated.

28. The method of claim 23, wherein the step (d) comprises:
(d1) receiving a wireless LAN signal from an arbitrary wireless LAN terminal, sending the received wireless LAN signal to a common layer of a Bluetooth protocol stack and a wireless LAN protocol stack, and converting the sent wireless LAN signal into the common layer data; and
(d2) sending the common layer data to the lowest layer of the Bluetooth protocol stack, converting the common layer data into a Bluetooth signal, and transmitting the Bluetooth signal to a Bluetooth terminal to which an IP address included in the converted Bluetooth signal is allocated.

29. A mixed protocol stack of Bluetooth and wireless LAN comprising:
a plurality of upper layers formed with layers common to a Bluetooth stack protocol and a wireless LAN protocol stack; and
a plurality of lower layers formed with layers different in the two protocol stacks.

30. The mixed protocol stack of claim 29, wherein the upper layers are stacked in order of the IP, the TCP or UDP, and the socket.

31. The mixed protocol stack of claim 29, wherein the lower layers include a Bluetooth protocol stack part and a wireless LAN protocol stack part, and in the Bluetooth protocol stack part, layers are stacked in order of radio frequency (RF), baseband, host controller interface (HCI), logical link control and adaptation protocol (L2CAP), RFCOMM, and point-to-point protocol (PPP) from the bottom, and in the wireless LAN protocol stack part, layers are stacked in order of the RF, the 802.11 medium access control (MAC), and logical link control (LLC) from the bottom.

32. A computer readable medium having embodied thereon a computer program for any one method of claims 15 through 28.
